(19) United States
(12) Patent Application Publication
(10) Pub. No.: US 2014/0351016 A1
(43) Pub. Date: Nov. 27, 2014

(54) GENERATING AND IMPLEMENTING CAMPAIGNS TO OBTAIN INFORMATION REGARDING PRODUCTS AND SERVICES PROVIDED BY ENTITIES

(71) Applicant: Syed S. Khundmiri, Spring, TX (US)

(72) Inventor: Syed S. Khundmiri, Spring, TX (US)

(21) Appl. No.: 14/283,266

(22) Filed: May 21, 2014

Related U.S. Application Data
(60) Provisional application No. 61/826,468, filed on May 22, 2013.

(51) Int. Cl. G06Q 30/02

(52) U.S. Cl. CPC G06Q 30/0203
USPC 705/7.32

(57) ABSTRACT

Systems and processes may generate and implement campaigns to obtain information regarding products and services provided an entity. A campaign may include one or more questions regarding a product or service offered by an entity, such as a merchant or service provider. The questions of a campaign may relate to an experience of a customer with respect to the product or service offered by the entity. After receiving answers to questions of a campaign, one or more actions may be performed based on the content of the answers. For example, a reward may be provided to a customer for answering questions of the campaign, a representative of an entity may contact the customer regarding answers to questions of the campaign, or a request may be provided to a customer to obtain video feedback from the customer regarding the experience of the customer with the entity.

### PRIORITY CLAIM AND CROSS-REFERENCE TO RELATED APPLICATION

This application claims the benefit of, and priority to, U.S. Provisional Patent Application No. 61/826,468, filed May 22, 2013, which is incorporated by reference herein in its entirety.

### BACKGROUND

Merchants may attempt to obtain information about the experiences of their customers in relation to the products and/or services offered by the merchants. Merchants may also obtain demographic information from customers. In this way, merchants may obtain information about their customers, such as preferred products or services to purchase, preferred features of products or services, and so forth. Some merchants may utilize information about customers to notify customers regarding current or future promotions, and assess the effectiveness of marketing. In some cases, merchants may determine sales conversion by measuring the number of individuals that inquire about obtaining products and/or services from the businesses in relation to the number of individuals that purchase products and/or services from the merchants. In one example, a merchant may obtain information about customers by providing the customers with a survey that asks questions about the experience of the customer with a product and/or service offered by the business. The surveys may be offered across a number of platforms, such as online or via a computing device. Furthermore, merchants may obtain feedback from customers by viewing third-party websites that collect reviews from customers.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 illustrates an environment to generate and implement campaigns to obtain information regarding products and services provided an entity.

FIG. 2 illustrates an electronic device to generate and implement campaigns to obtain information regarding products and services provided an entity.

FIG. 3 illustrates a system including multiple computing devices and a network to generate and implement campaigns to obtain information regarding products and services provided an entity.

FIG. 4 illustrates a user interface to login in to a system that generates and implements campaigns to obtain information regarding products and services provided an entity.

FIG. 5 illustrates a user interface to select a campaign to be launched in order to obtain customer feedback.

FIG. 6 illustrates a user interface to obtain identification information associated with a customer.

FIG. 7 illustrates a plurality of user interfaces to be provided during a campaign to obtain customer feedback.

FIG. 8 illustrates a user interface including a number of questions to obtain customer feedback in association with a campaign.

FIG. 9 illustrates a flow diagram of an example process to generate a campaign to obtain customer feedback.

FIG. 10 illustrates a flow diagram of an example process to provide a campaign to obtain customer feedback.

### DETAILED DESCRIPTION

Described herein are systems and processes to generate and implement campaigns to obtain information regarding products and services provided by entities. A campaign may include one or more questions regarding a product or service offered by a merchant. In some cases, the merchant may offer products and/or services via a brick and mortar location. In other cases, the merchant may offer products and/or services via a website. In additional scenarios, the merchant may be a mobile merchant that offers products and/or services via a vehicle or that performs services at a location associated with the customer. In still further instances, the merchant may offer products or services via a combination of modalities, such as via a brick and mortar location, via a website, at a location associated with a customer, via a vehicle, or a combination thereof. Additionally, products or services offered by the merchants may include tangible products, intangible products, online services, in-person services, or a combination thereof. Embodiments of systems and processes described herein may also be utilized by entities other than merchants, such as non-profits, governmental organizations, membership associations, and the like. The term “entity” will be used herein to describe merchants or other organizations that are the subject of a campaign. Further, the term “customer” as used herein will be used to describe an individual or group of individuals that obtain products and/or services from an entity. In some cases, a customer may obtain products or services from the entity by supplying value to the entity, such as currency. In other cases, an entity may provide products and/or services to a customer without obtaining value from the customer. In various embodiments, a customer may be a campaign responder when the customer provides answers to questions of a campaign.

In some cases, questions of a campaign may relate to an experience of a customer with respect to the product or service offered by an entity. The questions of the campaign may help the entity to determine whether a customer has had a favorable experience with a product or service or an unfavorable experience. The questions of a campaign may be related to the products and/or services offered by the entity. For example, a campaign for a first entity offering a first type of product and/or service, such as food and beverage products and services, may include a first set of questions, while a campaign for a second entity offering a second type of product or service, such as utility repair services, may include a second set of questions that is different from the first set of questions. In an embodiment, a campaign may include one or more questions provided by the entity associated with the campaign. The campaign may also include one or more questions generated by a service provider based on information provided by the entity to the service provider.

After receiving answers to questions of a campaign, one or more actions may be performed based on the content of the answers. For example, a reward may be provided to a customer from an entity or service provider for answering questions of the campaign. In another example, a representative of an entity may contact the customer regarding answers to questions of the campaign. To illustrate, when answers to questions of a campaign indicate that a customer is dissatisfied with a product or service offered by an entity, a representative of the entity, such as a manager or customer service representative may contact the customer to obtain more information about why the customer is dissatisfied. In an additional example, a request may be provided to a customer to obtain video feedback from the customer regarding the experience of the customer with the entity.

The embodiments of systems and processes described herein may provide an entity with real-time feedback regarding an experience of a customer with the entity. By providing an entity with real-time feedback from a customer, the entity may take actions to improve an experience of the customer with the entity or to provide rewards to the customer for providing feedback. Additionally, embodiments of the systems and processes described herein may provide access to results of campaigns to an entity via many different types of electronic devices (e.g., mobile phone, tablet computing device, laptop computing device, desktop computing device, wearable computing device, such as a watch, and the like). Entities may also access results of campaigns at various locations depending on the availability of communication networks. Thus, the embodiments of systems and processes described herein provide an entity with flexibility in accessing the results of campaigns that are related to products and/or services being offered by the entity.

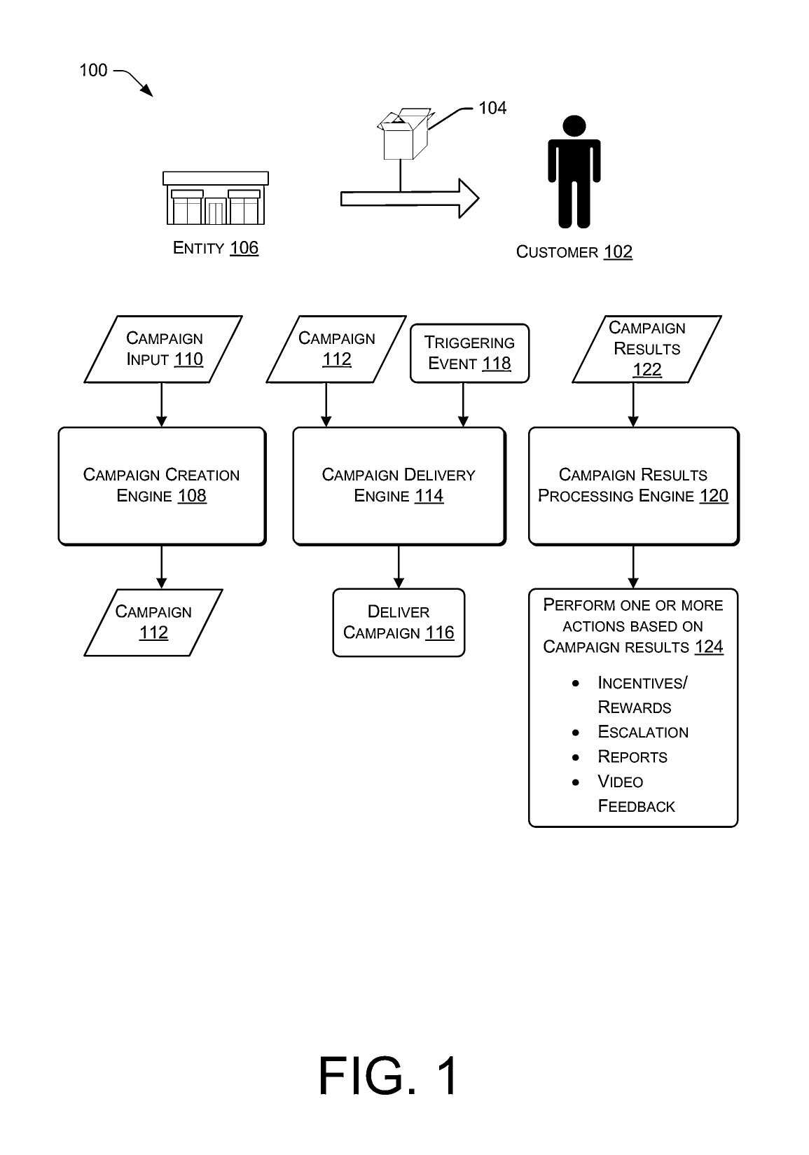

FIG. 1 illustrates an environment 100 to generate and implement campaigns to obtain information regarding products and services provided an entity. In particular, the feedback may be obtained in relation to a customer 102 acquiring an item 104, such as a product and/or a service, from an entity 106. In some cases, one or more of the operations described with respect to the environment 100 may be performed by one or more computing devices of a service provider (not shown), one or more computing devices of the entity 106, or one or more computing devices of both the entity 106 and a service provider. For example, one or more of the operations described with respect to the environment 100 may be performed by one or more computing devices, such as servers, of a service provider that generates and implements campaigns on behalf of entities. Additionally, one or more of the operations described with respect to FIG. 1 may be performed by an application being executed by a computing device of the entity 106, such as a mobile phone of the entity 106, a tablet computing device of the entity 106, etc. In some cases, the application executing on a computing device of the entity 106 may be provided by a service provider that generates and implements campaigns to obtain feedback from the customer 102. Furthermore, the operations described with respect to FIG. 1 may be distributed among one or more computing devices of a service provider and one or more computing devices of the entity 106.

The environment 100 includes a campaign creation engine 108 that may utilize campaign input 110 to generate a campaign 112. In an embodiment, the campaign creation engine 108 may generate questions and corresponding answers to the questions for the campaign 112 based on the campaign input 110. The campaign input 110 may be provided by an entity, such as the entity 106, that is the subject of the campaign 112, a service provider generating and implementing the campaign 112 on behalf of the entity 106, or both. In some cases, the campaign input 110 may include particular questions that the entity 106 has requested to be included in the campaign 112. For example, the entity 106 may provide a question to the campaign creation engine 108 to obtain feedback regarding a particular product, a particular service, a particular representative of the entity 106 (e.g., a particular employee), another particular aspect related to the entity 106 (e.g., ambiance of a brick and mortar location of the entity 106), combinations thereof, and the like.

The campaign input 110 may also include parameters provided by the entity 106 that are related to feedback that the entity 106 desires. To illustrate, the campaign input 110 may include an aspect of a product or service that is being offered by the entity 106, such as housekeeping service at a hotel. In these situations, the campaign creation engine 108 may utilize the parameter to generate questions related to the parameter, such as “On a scale of 1 to 5, how clean was your room?” In some cases, the campaign creation engine 108 may search a database of questions to obtain an appropriate question that corresponds to the parameter included in the campaign input 110. In various embodiments, questions included in the campaign 112 may be provided by the entity 106 and selected by the campaign creation engine 108 based on parameters provided by the entity 106.

The campaign input 110 may also include question sequencing information. In particular, the campaign input 110 may include an order set by the entity 106 in which questions are to be presented in the campaign 112. For example, the sequencing information may indicate that a first question is to be asked before a second question. In another example, the sequencing information may indicate that a first answer to a question results in a first additional question being provided to the customer 102, while a second answer to the question results in a second additional question being provided to the customer 102. In other situations, the campaign creation engine 108 may determine the sequencing of questions of the campaign 112 based on the content of questions and answers provided to the questions. For example, the campaign creation engine 108 may analyze content of a question and content of an answer to the question to identify a subsequent question to provide to the customer 102.

The environment 100 also includes a campaign delivery engine 114 that delivers a campaign to a customer. In the illustrative example of FIG. 1, the campaign delivery engine 114 may access the campaign 112 generated by the campaign creation engine 108 and deliver the campaign 112 to the customer 102 at 116. The campaign delivery engine 114 may deliver the campaign 112 to the customer 102 via one or more user interfaces. The one or more user interfaces used to deliver the campaign may be displayed by a computing device using a browser application or a campaign application being executed by the computing device. The user interfaces may include one or more questions and corresponding answers to the one or more questions. In some cases, the campaign delivery engine 114 may deliver the campaign 112 to the customer 102 as a series of user interfaces. For example, a first user interface in a series may include a first question and one or more answers to the first questions. After obtaining an answer to the first question, a second question may be provided in a second user interface along with corresponding answers to the second question. In other instances, the campaign may be delivered to the customer 102 via email, via messaging (e.g., short messaging service (SMS) messages, a messaging application, etc.), via a social media website, via a website of the entity, via a website of a service provider, or a combination thereof.

While in some cases, the sequencing and order of the questions of the campaign 112 may be predetermined before delivery of the campaign to the customer at 110, in other cases, the sequencing and order of the questions of the campaign 112 may be determined “on-the-fly,” that is while the campaign 112 is being delivered to the customer 102. For example, the campaign delivery engine 114 may serve a first user interface to a computing device that includes a first question of the campaign 112 and one or more answers to the question. In response to receiving an answer to the question, the campaign delivery engine 114 and/or the campaign creation engine 108 may determine a second question of the campaign 112 based on the answer received and serve a second user interface to the computing device that includes the second question and corresponding answers to the second question.

The campaign delivery engine 114 may deliver the campaign at 116 in response to detecting a triggering event 118. In some cases, the triggering event 118 may include the acquisition of a product or service from the entity 106. For example, during a transaction for the customer 102 to purchase the item 104 from the entity 106, such as via a point-of-sale terminal or via a mobile payments application, a triggering event signal may be generated that is provided to the campaign delivery engine 114. In response to detecting the triggering event signal corresponding to the purchase of the item 104 by the customer 102 from the entity 106, the campaign delivery engine 114 may deliver the campaign to the customer at 116. In another event, the triggering event 118 may correspond to an input from a user of a computing device. To illustrate, a representative of the entity 106 providing a product or service may login to a campaign application and select a campaign to be provided to a customer. In response to selection of the campaign by the representative of the entity 106, the campaign delivery engine 114 may deliver the campaign at 116.

Additionally, the environment 100 includes a campaign results processing engine 120 that obtains campaign results 122 and performs one or more actions based on the campaign results at 124. The campaign results 122 may include answers to questions of the campaign 112. In some situations, the campaign 112 may have been delivered to a number of customers and the campaign results 122 may include answers to questions from a plurality of instances of the campaign 112. The one or more actions to be performed based on the campaign results 122 at 124 may include providing incentives to customers to provide answers to questions of the campaign 112. For example, the customer 102 may receive a discount on the item 102 being offered by the entity 106 in response to the customer 102 providing answers to questions of the campaign 112. The one or more actions to be performed based on the campaign results 122 at 124 may also include escalation of the matter to a representative of the entity 106. In an example, if answers to questions of the campaign 112 indicate that the customer 102 is dissatisfied with the item 104, a representative of the entity 106 may be contacted, such as via email, messaging, telephone call, combinations thereof, and the like. In this way, the representative of the entity 106 may respond to the issues causing the dissatisfaction on the part of the customer 102.

Furthermore, the entity 106 may obtain reports regarding the campaign results 122 as part of the one or more actions to be performed based on the campaign results 122 at 124. The reports may indicate a frequency of answers with respect to particular questions of the campaign 112. The reports may also indicate a number of customers that responded to the campaign 112, information about the customers that responded to the campaign 112, (e.g., age, location, etc.), information about products and/or services of the entity 106 that were included in the campaign results, or combinations thereof. The reports may include charts, graphs, or other illustrations showing various combinations of the campaign results 122. In some cases, the one or more actions to be performed based on the campaign results 122 at 124 may include obtaining video feedback from a customer, such as the customer 102. In some cases, the video feedback may be obtained when the customer 102 provides specified answers to questions of the campaign 112. In other situations, the video feedback may be obtained based on demographic information of the customer 102, based on a purchase history of the customer 102 with the entity 106, or both.

In an illustrative example, a customer may obtain a meal at a restaurant. As the waiter brings the tab to the customer, the waiter may ask the customer if they would like to answer questions of a campaign. After logging in to a campaign application on an electronic device, such as a mobile phone or a tablet computing device, the waiter may provide the electronic device to the customer that displays user interfaces including questions of the campaign. The questions of the campaign may be related to the experience of the customer at the restaurant. For example, the questions of the campaign may be related to the customer's waiter, the staff of the restaurant, the food of the restaurant (including particular items ordered by the customer), the atmosphere of the restaurant, and so forth. The customer may select answers to the questions of the campaign using an input device of the electronic device, such as a touch screen, a camera, or a microphone. Upon receiving answers to the questions, the answers may be stored by the electronic device and/or sent to a service provider that has provided the campaign application being executed by the electronic device. After receiving the answers to the questions, the customer may receive a reward from the restaurant, such as a discount on the current meal or a discount on a subsequent meal. In some cases, the campaign application or a service provider may determine that the customer was dissatisfied with some aspect of the restaurant based on the answers provided to the customer. In these situations, an email or message may be sent to a manager of the restaurant and the manager can then engage the customer about the one or more aspects of the restaurant that were dissatisfying to the customer. In this way, the customer may have an improved impression of the restaurant due to the dissatisfaction of the customer being promptly addressed.

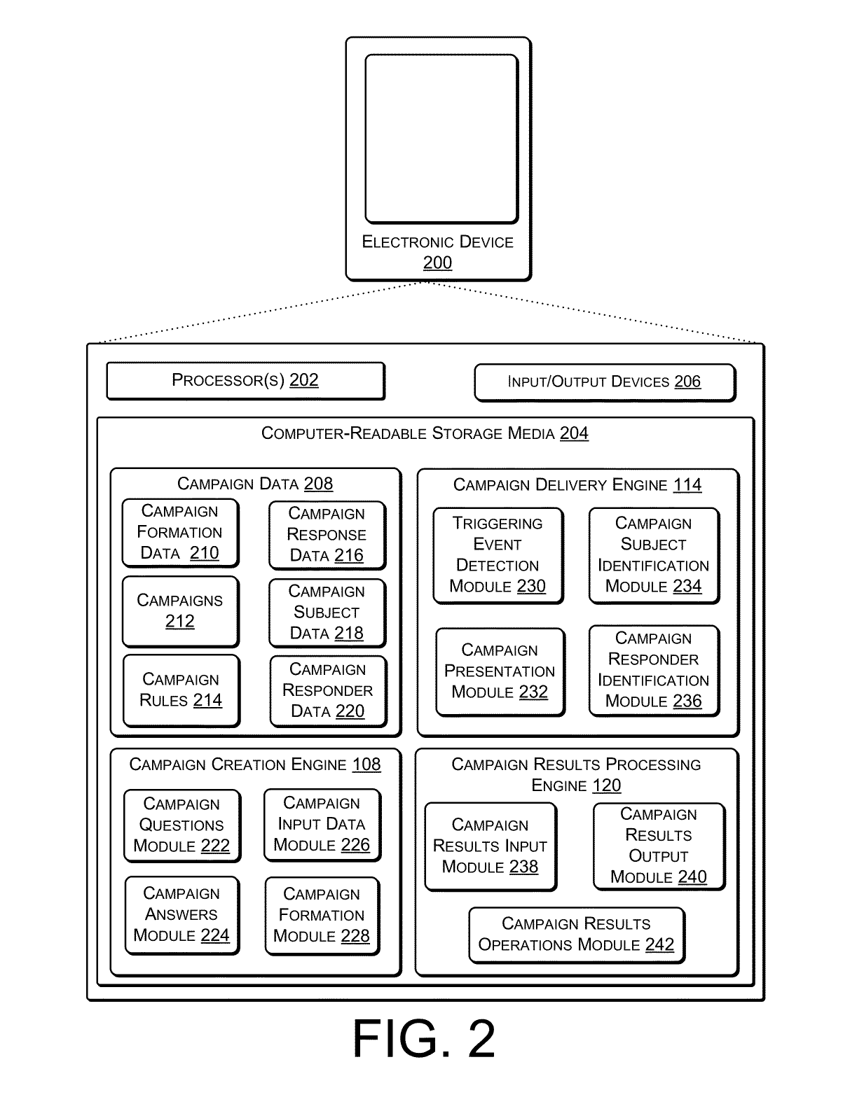

FIG. 2 illustrates an electronic device 200 to generate and implement campaigns to obtain information regarding products and services provided an entity. The electronic device 200 may include one or more processors, such as processor 202, and one or more computer-readable storage media, such as computer-readable storage media 204. The processor 202 may include a hardware processing unit, such as a central processing unit, a graphics processing unit, or both. In an implementation, the computer-readable storage media 204 may include volatile and nonvolatile memory and/or removable and non-removable media implemented in any type of technology for storage of information, such as computer-readable instructions, data structures, program modules or other data. Such computer-readable storage media 204 may include, but is not limited to, RAM, ROM, EEPROM, flash memory or other memory technology, CD-ROM, digital versatile disks (DVD) or other optical storage, solid state storage, magnetic disk storage, removable storage media, or any other medium that can be used to store the desired information and that can be accessed by the electronic device 200. Depending on the configuration of the electronic device 200, the computer-readable storage media 204 may be a type of tangible computer-readable storage media and may be a non-transitory storage media. The electronic device 200 may also include one or network interfaces (not shown) to communicate with other computing devices via a network (not shown). The electronic device 200 may also include one or more input/output devices 206. For example, the electronic device 200 may include and/or be in communication with one or more display devices, a touch screen, a keypad, a keyboard, a pointer device, one or more speakers, a microphone, one or more cameras, combinations thereof, and the like. Additionally, the electronic device 200 may include at least a portion of a portable computing device, a smart phone, a mobile phone, a tablet computing device, a laptop computing device, a desktop computing device, a wearable computing device (e.g. a watch, eyeglasses, jewelry), a portable gaming device, a gaming console, a media device (e.g. a television, a radio), an appliance, a point-of-sale terminal, or a combination thereof.

The computer-readable storage media 204 may be used to store data used to generate and implement campaigns to obtain information regarding products and services provided an entity, such as campaign data 208. The campaign data 208 may be obtained from an entity via one or more user interfaces provided by a service provider, in some cases. In other cases, the campaign data 208 may be obtained by a representative of a service provider having oral and/or written communication with an entity. The representative of the service provider may then enter the information obtained from the entity via a series of user interfaces. In additional scenarios, the campaign data 208 may be obtained by the electronic device 200 accessing information stored on computing devices of an entity and/or websites of an entity. For example, the electronic device 200 may have received permissions from an entity to access certain records or documents to be used in generating and implementing a campaign for the entity.

The campaign data 208 may include campaign formation data 210 that is used to generate campaigns 212. In particular, the campaign formation data 210 may include questions that may be included in the campaigns 212. In some cases, the questions may be provided by entities associated with the campaigns 212. For example, an entity may provide particular questions that are to be provided in association with a particular campaign 212. The questions may also be provided by a service provider that generates and implements campaigns to obtain customer feedback.

The campaign formation data 210 may also include possible answers to questions of the campaigns 212. For example, the multiple answers may be associated with some questions and a customer may be able to select one or more of the answers for each of the questions. The answers may be provided by the entities providing the questions for the campaigns 212, in some scenarios. In other situations, the answers may be provided by a service provider that generates and implements the campaigns 212 to obtain customer feedback.

The campaign formation data 210 may also include sequencing information that indicates an order in which to provide questions of the campaigns 212. To illustrate, the sequencing information may indicate that a first question is to be provided before a second question of one of the campaigns 212. The sequencing information may also indicate questions that are to be provided in response to particular answers to a previously provided question. For example, receiving a first answer to a question may cause a first additional question to be provided to a customer, while receiving a second answer to the question may cause a second additional question different from the first additional answer to be provided to the customer.

The campaign formation data 210 may also include indexing information used to indicate that particular questions may be included in the same campaign 212. The indexing information may also indicate that particular questions are associated with specified answers. Additionally, the campaign formation data 210 may include information indicating questions and/or answers that are associated with different products or services offered by entities. Furthermore, the campaign formation data 210 may include information indicating questions and/or answers that are to be provided to specified customers. For example, the campaign formation data 210 may indicate that customers in a particular location are to be associated with particular questions for one or more of the campaigns 212. In some cases, the campaign formation data 210 may also include preferences of entities with respect to the questions and/or answers that are to be provided in association with campaigns of those entities. In various embodiments, the campaign formation data 212 may include information indicating the campaigns 212 that are associated with a particular entity or with particular entities. To illustrate, the campaign formation data 212 may indicate that a specified campaign 212 is to be provided in association with a particular entity or that the specified campaign 212 is to be provided in association with a particular group of entities.

Individual campaigns 212 include one or more questions selected from the questions included in the campaign formation data 210. The individual campaigns 212 may also include one or more answers for individual questions of the campaigns 212. In an illustrative example, a particular campaign 212 may include a first question having a plurality of first answers, a second question having two second answers, a third question having a plurality of third answers, and a fourth question having a plurality of fourth answers. Additionally, the particular campaign 212 may include sequencing information indicating that the second question is to be provided after receiving one or more answers to the first question. The sequencing information for the particular campaign 212 may also indicate that in response to receiving one of the two answers to the second question, the third question is to be provided to the customer and in response to receiving the other of the two answers to the second question, the fourth question is to be provided to the customer.

The campaign data 208 may also include campaign rules 214 that specify when the campaigns 212 are to be provided to customers. For example, the campaign rules 214 may specify triggering events for the campaigns 212. To illustrate, the campaign rules 214 may indicate that a first portion of the campaigns 212 are to be provided in response to determining that a particular product or service is being acquired by a customer from a particular entity. In an illustrative embodiment, the campaign rules 214 may indicate that a particular campaign 212 is to be provided to a point-of-sale terminal at a location of an entity in response to determining that a customer is conducting a transaction to buy one or more particular products from the entity via the point-of-sale terminal. In other situations, the campaign rules 214 may indicate that a second portion of the campaigns 212 are to be provided in response to the selection of the campaign via an input device 206 of the electronic device. In another illustrative embodiment, the campaign rules 214 may indicate that in response to receiving input from a customer of an entity or a representative of the entity via an input device 206 (e.g., a touch screen) a particular campaign 212 is to be provided to a customer, such as via a display of the electronic device 200.

The campaign data 208 may also include campaign response data 216 that includes answers provided by customers to questions of the campaigns 212. In some cases, the answer to a question of a campaign 212 may include an answer selected from a plurality of answers to a question, such as an answer to a multiple choice question. In other cases, the answer to a question of a campaign 212 may include an answer that indicates a score, a level, or a rating associated with a criteria included in the question. In additional situations, the answer to a question of a campaign 212 may include text entered by a user, such as a customer of an entity or a representative of an entity.

In addition, the campaign data 208 may include campaign subject data 218 that includes information about entities that are the subject of the campaigns 212. For example, the campaign subject data 218 may include one or more locations of an entity, contact information of an entity (e.g., email address, phone number), identifiers of representatives of an entity (e.g., name, login information, password), products and/or services offered by an entity, identifiers of campaigns associated with an entity, reporting parameters for an entity, such as preferences regarding the information about campaigns of the entity that are to be reported to the entity, information about an entity that is to be used in generating questions and/or answers of a campaign (e.g. customer service criteria, preferred types of questions and/or answers), or a combination thereof.

The campaign data 208 may also include campaign responder data 220 that includes information about customers that respond to questions of a campaign of an entity and/or customers that may respond to questions of a campaign of an entity. The campaign responder data 220 may include contact information of customers of entities associated with the campaigns 212, identifiers of customers of entities associated with the campaigns 212 (e.g., name, login information, password information), preferences of customers of entities associated with the campaigns 212 (e.g., preferences to opt-out of certain campaigns 212, preferences to opt-in to certain campaigns 212), answers to questions of particular campaigns 212, information related to providing answers to particular campaigns 212 (e.g., time that a campaign was completed, location that the campaign was completed, time taken to complete a campaign), or combinations thereof.

The computer-readable storage media 204 may also be used to store any number of functional components that are executable by the one or more processors 202. In many implementations, these functional components comprise instructions or programs that are executable by the one or more processors 202 and that, when executed, implement operational logic for performing the operations attributed to the electronic device 200. Functional components of the electronic device 200 that may be executed on the one or more processors 202 for implementing the various functions and features related to generating and implementing campaigns to obtain customer feedback, as described herein, include the campaign creation engine 108 that includes a campaign questions module 222, a campaign answers module 224, a campaign input data module 226 and a campaign formation module 228. The functional components of the electronic device 200 may also include the campaign delivery engine 114 that includes a triggering event detection module 230, a campaign subject identification module 234, a campaign responder identification module 236, and a campaign presentation module 232. Furthermore, the functional components of the electronic device 200 may include the campaign results processing engine 120 that includes a campaign results input module 238, a campaign results output module 240, and campaign results operations module 242.

The campaign questions module 222 of the campaign creation engine 108 may obtain questions for one or more of the campaigns 212. In some cases, the campaign questions module 222 may provide one or more user interfaces to accept input from a user that includes questions to be provided as part of a campaign. For example, the campaign creation engine 108 may receive input via a user interface from an entity requesting to provide a campaign. In another example, the campaign creation engine 108 may receive input via a user interface from a representative of a service provider to enter questions of a campaign on behalf of an entity. The campaign questions module 222 may then provide one or more user interfaces to obtain input from the user regarding questions to be asked during the campaign. The one or more user interfaces may be provided as a series of user interfaces that guide a user through a process to select and/or create questions for a campaign.

In one example, the campaign questions module 222 may provide one or more user interfaces including text boxes to receive text for questions of a campaign. In another example, the campaign questions module 222 may provide one or more user interfaces including a template for generating questions of a campaign. In an additional example, the campaign questions module 222 may generate sample questions via one or more user interfaces that a user may select to be included in a campaign and/or that an entity can edit for inclusion in a campaign. The campaign questions module 222 may also obtain questions for a campaign of an entity from a third-party service provider. The sample questions generated by the campaign questions module 222 and/or the questions obtained from the third-party service provider may be based on input received from the entity, such as a type of question to be generated (e.g., multiple choice, short answer, rating,) or a topic for the question (e.g., a particular product or service of the entity, particular criteria to be evaluated).

The campaign creation engine 108 may also include a campaign answers module 224 that obtains information regarding answers to questions of a campaign. In some cases, the campaign answers module 224 may provide one or more user interfaces to receive input regarding answers to questions of a campaign. The input regarding the answers to the campaign may be provided by an entity for which a campaign may be created and/or by a representative of a service provider providing a campaign on behalf of an entity. The campaign answers module 224 may be invoked each time that a question is obtained and/or generated by the campaign questions module 222. The answer(s) to a particular question may be entered by a user of the electronic device, in some cases, while in other cases, the campaign answers module 224 may generate one or more answers to a question. For example, the campaign answers module 224 may generate one or more answers to a question based on the content of a question. In particular, the campaign answers module 224 may determine that a particular type of answer for a question (e.g., multiple choice, a rating, short answer, etc.) based on words included in the question, a category of the question, or both. In other situations, the campaign answers module 224 may access the campaign data 208 to match one or more answers to a question. To illustrate, the campaign data 208 may indicate that certain answers correspond to certain questions and the campaign answers module 224 may determine that one or more particular answers are associated with a particular question based on the campaign data 208. The campaign answers module 224 may also obtain one or more answers to a question from a third-party service provider based on content of the question.

Further, the campaign creation engine 108 may include the campaign input data module 226 to receive input regarding generating and implementing campaigns to obtain customer feedback. For example, the campaign input data module 226 may obtain input from a user regarding questions and answers for a campaign. To illustrate, the campaign input data module 226 may provide a series of user interfaces that guide a user through the process of providing questions and answers for a campaign. The campaign input data module 226 may also obtain input from a user regarding criteria related to when a campaign is to be provided to a customer. In one example, the campaign input data module 226 may receive input indicating a time or range of times for a campaign to be provided, a date or range of dates for a campaign to be provided, one or more locations of the entity at which a campaign is to be provided, triggering events that cause a campaign to be provided, characteristics of customers to be provided with a campaign (e.g., location, demographic information, shopping history with an entity, previous answers given to questions of one or more campaigns), combinations thereof, and the like.

The campaign creation engine 108 includes a campaign formation module 228 that may generate the campaigns 212. In some cases, the campaign formation module 228 may generate a campaign by obtaining questions and answers for the campaign. In some cases, the questions and answers to a campaign may be predetermined by an entity associated with the campaign. For example, the entity may provide the questions and answers for the campaign through one or more user interfaces, through communications with a service provider (e.g., phone conversations, in-person meetings, emails, messaging), or both. In other situations, the campaign formation module 228 may generate a campaign by analyzing information associated with an entity to obtain questions and answers for a campaign. To illustrate, the campaign formation module 228 may generate questions and answers for a campaign based on criteria provided by an entity that is the subject of the campaign, such as a restaurant wanting to evaluate the quality of its servers or the quality of its desserts. The criteria may include a particular service or product offered by an entity or an aspect of a particular service or product offered by an entity. The campaign formation module 228 may also analyze data for an entity, such as sales data, employee data (e.g., employee turnover, employee reviews, etc.), other metrics, or combinations thereof, to generate questions for a campaign. In an embodiment, the campaign formation module 228 may select questions from a group of questions based on an analysis of information associated with an entity related to a campaign. In other embodiments, the campaign formation module 228 may generate new questions for a campaign based on an analysis of the information of an entity associated with a campaign.

The campaign formation module 228 may also generate or obtain questions and answers for a campaign based on questions and answers of campaigns that have previously been provided. For example, the campaign formation module 228 may determine that a first entity has similarities in the products and/or services being offered as a second entity, where the second entity was associated with a campaign that had been previously presented to customers. The campaign formation module 228 may then generate questions and answers of a campaign for the first entity based at least partly on the questions and answers of the campaign associated with the second entity.

The campaign formation module 228 may also provide identifiers for questions, answers, and campaigns, such that one or more answers for a particular question may be identified and such that the questions and answers for a particular campaign may be identified. In some instances, the campaign formation module 228 may generate index data that corresponds particular questions and answers with a particular campaign. The campaign formation module 228 may also obtain or generate sequencing information for questions of a campaign. The sequencing information may indicate an order in which questions are to be presented during a campaign. In this way, when a campaign is provided to a customer, the questions and answers for the campaign may be accessed based on the identifiers generated by the campaign formation module 228 and the sequence with which the questions and answers are provided may be based on the sequencing information.

The campaign delivery engine 114 includes the triggering event detection module 230 that monitors for triggering events associated with individual campaigns 212. In some cases, the triggering event detection module 230 may receive information indicating that a triggering event has occurred. In other cases, the triggering event detection module 230 may query other components of the electronic device 200 or components of an additional computing device to determine when a triggering event has occurred.

In an embodiment, the triggering event detection module 230 may determine that a triggering event has occurred in response to receiving input indicating selection of a campaign by a user of the electronic device 200. In another embodiment, the triggering event detection module 230 may determine that a triggering event has occurred in response to determining that a transaction is taking place to purchase a product and/or service from an entity. For example, the triggering event detection module 230 may receive information from a point-of-sale terminal, a website, or a mobile payments application that a customer is purchasing a product and/or service from an entity. To illustrate, the triggering event detection module 230 may determine that a triggering event has occurred when a customer is checking out of a hotel or paying for food items from a grocery store. The triggering event detection module 230 may also determine that a triggering event has occurred in response to determining that specified criteria have been satisfied. In some situations, the criteria may include characteristics of individuals. In other instances, the criteria may include dates, times, and locations for providing a campaign.

The campaign delivery engine 114 also includes a campaign presentation module 232 that may provide campaigns to customers. In some cases, the campaign presentation module 232 may provide the campaign to a customer by providing one or more user interfaces that include questions and answers of a campaign. For example, the campaign presentation module 232 may provide a series of user interfaces that each include questions and/or possible answers to the questions. In other cases, the campaign presentation module 232 may provide the campaign to a customer via email or messaging. In additional scenarios, the campaign presentation module 232 may provide a campaign to a customer through a telephone call, such as via an Interactive Voice Response (IVR) system.

In an embodiment, user interfaces provided by the campaign presentation module 232 may include, in some situations, a user interface element for obtaining text answers from a user. Additionally, the user interfaces provided by the campaign presentation module 232 may include elements for selecting one or more answers from among a group of answers, such as radio buttons. Further, the user interfaces provided by the campaign presentation module 232 may also include elements for indicating a rating or a score on a scale, such as a sliding scale indicating a number between 1 to 5 or a drop down menu to select a number for a rating between 1 to 5 or a number of stars for a rating from among four or five stars.

In some cases, the campaign presentation module 232 may be invoked by the triggering event detection module 230. For example, in response to detecting a triggering event, the triggering event detection module 230 may invoke the campaign presentation module 232 to provide a campaign to a customer. The campaign presentation module 232 may provide the campaign via one or more output devices 206 of the electronic device 200, in some instances. To illustrate, the campaign presentation module 232 may provide information about a campaign via a display device of the electronic device 200, such as one or more user interfaces of the campaign. Additionally, the campaign presentation module 232 may provide audio data of a campaign via speakers of the electronic device 200 and receive audio data via one or more microphones of the electronic device 200. In a particular embodiment, the campaign presentation module 232 may provide audio including questions of a campaign via speakers of the electronic device 200. Furthermore, the campaign presentation module 232 may provide video data and/or photo data of a campaign via a display device of the electronic device 200, via one or more speakers of the electronic device 200, or both. In an example, the campaign presentation module 232 may provide a video presentation including questions of a campaign via a display device of the electronic device 200 and possible audio corresponding to the video presentation via speakers of the electronic device 200. In other situations, the campaign presentation module 232 may present the campaign by sending data related to the campaign, such as audio data, video data, user interface data, or combinations thereof to another computing device.

In addition, the campaign delivery engine 114 includes a campaign subject identification module 234 that obtains data to identify a subject of a campaign. In one example, the campaign subject identification module 234 may provide one or more user interfaces to obtain input indicating an entity associated with a campaign. To illustrate, the campaign subject identification module 234 may provide a user interface to obtain login information of a representative of an entity that is the subject of a campaign. In some cases, a representative of an entity that is the subject of a campaign may log in to an account of the entity with a service provider and/or a campaign application executing on the electronic device 200 to initiate an instance of a campaign for a particular customer. In other situations, a representative of an entity that is the subject of a campaign may log in to an account of the entity with a service provider and/or a campaign application executing on the electronic device 200 to generate a campaign for the entity.

Further, the campaign delivery engine 114 includes a campaign responder identification module 236 to obtain information regarding customers that respond to questions of the campaigns 212. For example, the campaign responder identification module 236 may provide one or more user interfaces to obtain input from a customer that identifies the customer, such as an identifier of the individual, contact information of the individual, or both. In some cases, the identifier of the individual may be provided by a service provider that generates and implements campaigns to obtain customer feedback. In other situations, the identifier of the individual may be provided by the entity that is the subject of the campaign.

The campaign results processing engine 120 includes a campaign results input module 238 to obtain answers to questions of the campaigns 212. In some cases, the answers to the questions of the campaigns 212 may be provided via one or more user interfaces generated by the campaign presentation module 232. In other situations, the answers to the questions of the campaigns 212 may include audio content obtained using one or more microphones of the electronic device 200. In still additional instances, the answers to the questions of the campaigns 212 may include video content obtained using one or more cameras of the electronic device 200. The campaign results input module 238 may store answers to questions of the campaigns 212 as a portion of the campaign response data 216.

The campaign results processing engine 120 includes the campaign results output module 240 to output information associated with answers to questions of the campaigns 212. For example, the campaign results output module 240 may generate reports indicating answers to questions of the campaigns 212. In some cases, the reports may be customized for one or more entities based on preferences provided by the one or more entities. The reports generated by the campaign results output module 240 may include graphs, charts, tables, other visual graphics, or combinations thereof, indicating answers to questions of campaigns 212.

In an embodiment, the campaign results output module 240 may generate metrics associated with the campaigns 212. To illustrate, the campaign results output module 240 may determine a frequency that certain answers are provided with respect to a corresponding question. In other instances, the campaign results module 240 may determine characteristics of customers that provide certain answers to questions and/or the campaign results module 240 may determine that certain answers to questions are associated with various criteria. In an illustrative example, the campaign results module 240 may determine for a restaurant, customers purchasing dessert on Wednesdays are very satisfied with the product, while customers purchasing dessert on Saturdays are not satisfied with the product. The campaign results output module 240 may provide reports indicating the metrics generated by the campaign results output module 240.

Additionally, the campaign results processing engine 120 includes the campaign results operations module 242 to perform actions based on the answers provided by customers to questions of the campaigns 212. In some cases, the campaign results operations module 242 may determine that incentives or rewards are to be provided to a customer providing answers to questions of a campaign. In an embodiment, the campaign results operations module 242 may determine that incentives or rewards are to be provided to a customer based at least partly on the content of the answers provided by the individual, previous interactions of the customer with the entity (e.g., shopping history, frequency of interaction by the customer with the entity), other criteria provided by the entity (e.g., time of day, inventory of the entity, etc.), or combinations thereof. The incentives may be proposed to a customer before providing the customer with the campaign, while the rewards may be given to a customer after the customer has provided answers to questions of the campaign.

In other embodiments, the campaign results operations module 242 may determine that an escalation event has occurred based on answers to questions of a campaign provided by a customer. For example, the campaign results operations module 242 may determine that an answer to a single question or that answers to multiple questions satisfy a threshold criteria for determining that an escalation event has occurred. To illustrate, the campaign results operations module 242 may determine that a customer has provided a rating of less than 2 stars as answers to at least 3 questions of a campaign. In response, the campaign results operations module 242 may determine that an escalation event has occurred. In another situation, the campaign results operations module 242 may determine that a customer has provided an answer of “very dissatisfied” with respect to a question of a campaign and, as a result, determine that an escalation event has occurred. In response to determining that an escalation event has occurred, the campaign results operations module 242 may send information to a representative of an entity associated with the campaign indicating that an escalation event has occurred. In an example, the campaign results operations module 242 may send an alert via email, via an automated phone call, via messaging, or a combination thereof, to a representative of an entity, such as a manager, indicating that an escalation event has occurred.

Additionally, the campaign results operations module 242 may provide results of campaigns to third-party websites. For example, the campaign results operations module 242 may provide results of campaigns to social media websites. In some cases, the campaign results operations module 242 may provide results of campaigns to webpages of a social media website related to an account of an entity associated with the campaign. In other cases, the campaign results operations module 242 may provide results of a campaign to a micro-blogging account related to an entity associated with the campaign. In additional scenarios, the campaign results operations module 242 may provide results of campaigns to a site of an entity associated with the campaign or to an online retail website. In still other situations, the campaign results operations module 242 may provide results of a campaign to websites that collect reviews related to merchants.

The campaign results operations module 242 may also provide customers with the opportunity to provide video feedback regarding an experience with an entity associated with a campaign. In some cases, the video feedback may be provided via a camera of the electronic device 200. The campaign results operations module 242 may, in some scenarios, enable a customer to provide video feedback in response to input provided by the customer indicating a request to provide video feedback. The campaign results operations module 242 may also enable a customer to provide video feedback in response to input from a representative of an entity to initiate capturing video feedback from a customer. In additional embodiments, the campaign results operations module 242 may determine that an individual is to provide video feedback with regard to an entity based, at least partly on, answers to questions of a campaign provided by the individual. For example, the campaign results operations module 242 may initiate capturing video feedback from a customer or provide the customer with an option to provide video feedback in response to determining that the answers to one or more questions of a campaign satisfy one or more criteria. To illustrate, the campaign results operations module 242 may determine that a customer may provide video feedback in response to determining that a threshold number of answers to a campaign indicate a rating of at least 3 out of 5 stars for aspects of a product or service provided by the entity that is the subject of the campaign.

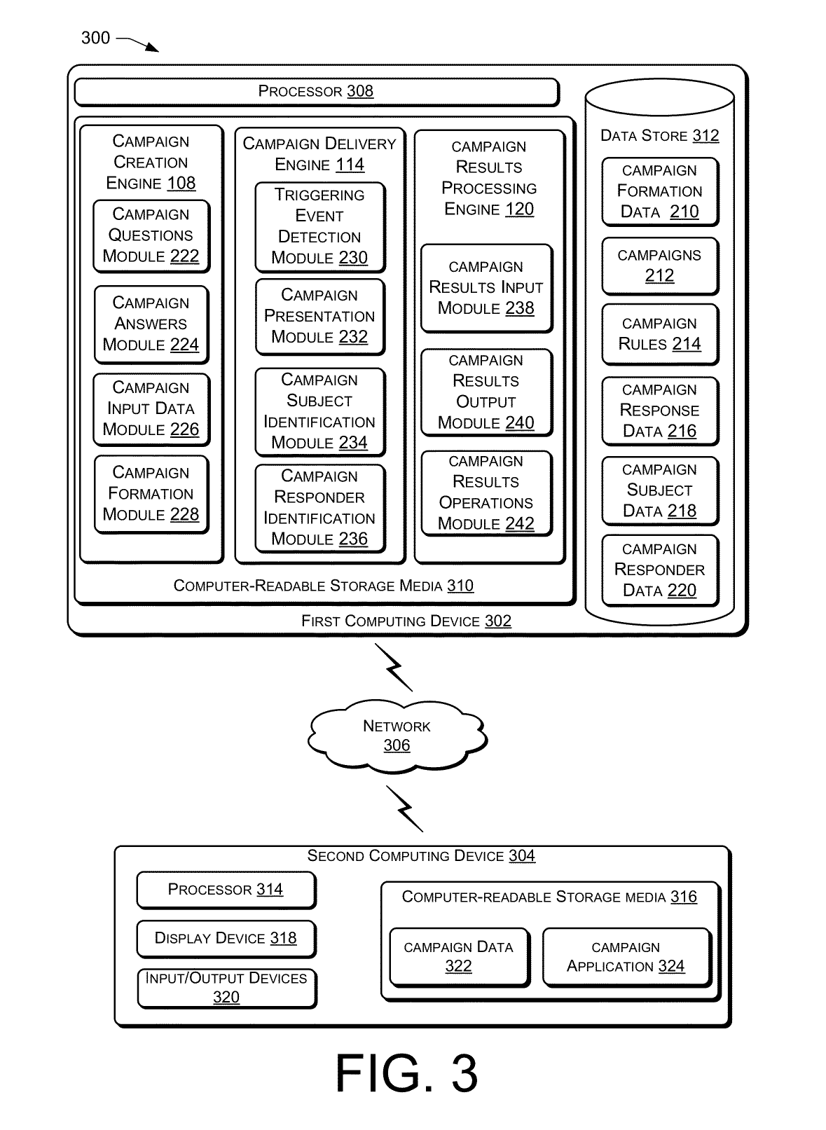

FIG. 3 illustrates a system 300 including multiple computing devices and a network to generate and implement campaigns to obtain customer feedback. In particular, the system 300 includes a first computing device 302 that may be in communication with a second computing device 304 via a network 306. The network 306 may include one or more of the Internet, a cable network, a satellite network, a wide area wireless communication network, a wired local area network, a wireless local area network, or a public switched telephone network (PSTN).

The first computing device 302 may be a computing device of a service provider that generates and implements campaigns to obtain customer feedback. For example, the first computing device 302 may be a server of a service provider. In some cases, the operations described with respect to the first computing device 302 may be performed by multiple computing devices of a service provider, such as a server farm or a cloud computing architecture. In some cases, the first computing device 302 and the second computing device 304 may exchange communications via the network 304 in order to jointly perform operations related to generating and implementing campaigns to obtain customer feedback.

The first computing device 302 may include one or more processors, such as processor 308. The one or more processors 308 may include at least one hardware processor, such as a microprocessor. In some cases, the one or more processors 308 may include a central processing unit (CPU), a graphics processing unit (GPU), or both a CPU and GPU, or other processing units. Additionally, the one or more processors 308 may include a local memory that may store program modules, program data, and/or one or more operating systems.

In addition, the first computing device 302 may include one or more computer-readable storage media, such as computer-readable storage media 310. The computer-readable storage media 310 may include volatile and nonvolatile memory and/or removable and non-removable media implemented in any type of technology for storage of information, such as computer-readable instructions, data structures, program modules or other data. Such computer-readable storage media 310 may include, but is not limited to, RAM, ROM, EEPROM, flash memory or other memory technology, CD-ROM, digital versatile disks (DVD) or other optical storage, magnetic cassettes, magnetic tape, solid state storage, magnetic disk storage, RAID storage systems, storage arrays, network attached storage, storage area networks, cloud storage, removable storage media, or any other medium that can be used to store the desired information and that can be accessed by a computing device. Depending on the configuration of the first computing device 302, the computer-readable storage media 310 may be a type of tangible computer-readable storage media and may be a non-transitory storage media.

The computer-readable storage media 310 may be used to store any number of functional components that are executable by the one or more processors 308. In many implementations, these functional components comprise instructions or programs that are executable by the one or more processors 308 and that, when executed, implement operational logic for performing the operations attributed to the first computing device 302. Functional components of the first computing device 302 that may be executed on the one or more processors 308 for implementing the various functions and features related to generating and implementing campaigns to obtain customer feedback, as described herein, include the campaign creation engine 108 that includes the campaign questions module 222, the campaign answers module 224, the campaign input data module 226 and the campaign formation module 228 described in detail with respect to FIG. 2. The functional components of the electronic device 200 may also include the campaign delivery engine 114 that includes the triggering event detection module 230, the campaign subject identification module 234, the campaign responder identification module 236, and the campaign presentation module 232 described in detail with respect to FIG. 2. Furthermore, the functional components of the electronic device 200 may include the campaign results processing engine 120 that includes the campaign results input module 238, the campaign results output module 240, and the campaign results operations module 242 described in detail with respect to FIG. 2.

The first computing device 302 may also include, or is coupled to, a data store 312 that may include, but is not limited to, RAM, ROM, EEPROM, flash memory, one or more hard disks, solid state drives, optical memory (e.g. CD, DVD), or other non-transient memory technologies. The data store 312 may maintain information that is utilized by the first computing device 302 and/or the second computing device 304 to perform operations related to generating and implementing campaigns to obtain customer feedback. For example, the data store 312 may store the campaign formation data 210, the campaigns 212, the campaign rules 214, the campaign response data 216, the campaign subject data 218, and the campaign responder data 220 described in detail with respect to FIG. 2.

The second computing device 304 may include one or more processors, such as processor 314, and one or more computer-readable storage media, such as computer-readable storage media 316. The processor 314 may include a hardware processing unit, such as a central processing unit, a graphics processing unit, or both. In an implementation, the computer-readable storage media 316 may include volatile and nonvolatile memory and/or removable and non-removable media implemented in any type of technology for storage of information, such as computer-readable instructions, data structures, program modules or other data. Such computer-readable storage media 316 may include, but is not limited to, RAM, ROM, EEPROM, flash memory or other memory technology, CD-ROM, digital versatile disks (DVD) or other optical storage, solid state storage, magnetic disk storage, removable storage media, or any other medium that can be used to store the desired information and that can be accessed by the second computing device 304. Depending on the configuration of the second computing device 304, the computer-readable storage media 316 may be a type of tangible computer-readable storage media and may be a non-transitory storage media. The second computing device 304 may also include one or network interfaces (not shown) to communicate with other computing devices via the network 306. The second computing device 302 may also include one or more display devices 318. Further, the second computing device 302 may include one or more additional input/output devices 320. For example, the second computing device 304 may include and/or be in communication with one or more display devices, a touch screen, a keypad, a keyboard, a pointer device, one or more speakers, a microphone, one or more cameras, combinations thereof, and the like. Additionally, the second computing device 304 may include a portable computing device, a smart phone, a mobile phone, a tablet computing device, a laptop computing device, a desktop computing device, a wearable computing device (e.g. a watch, eyeglasses, jewelry), a portable gaming device, a gaming console, a media device (e.g. a television, a radio), an appliance, or a combination thereof.

In an implementation, the computer readable storage media 316 may store campaign data 322. The campaign data 322 may include questions associated with campaigns, potential answers to the questions of the campaign, actual responses to questions of the campaign, sequencing information associated with campaigns, or combinations thereof. In an embodiment, the campaign data 322 may include any data that may be used to generate a campaign and obtain answers to questions of the campaign. In some cases, the campaign data 322 may be obtained from the data store 312. Additionally, the campaign data 322 may include at least a subset of a portion of the data stored by the data store 312.

The computer-readable storage media 316 may also include a campaign application 324 that includes computer-readable instructions that are executable by the processor 314 to provide questions to campaigns and obtain answers to the questions. In some cases, the campaign application 324 may perform one or more of the operations of the campaign creation engine 108, the campaign delivery engine 114, the campaign results processing engine 120, or a combination thereof described with respect to FIG. 1 and FIG. 2. In other situations, the campaign application 324 may operate in conjunction with the campaign creation engine 108, the campaign delivery engine 114, the campaign results processing engine 120, or a combination thereof, to generate and implement campaigns to obtain customer feedback.

In an illustrative example, the first computing device 302 may include a server of a service provider that generates and implements campaigns to obtain customer feedback. Additionally, the second computing device 304 may include a computing device of a customer or a representative of an entity that is the subject of a campaign provided by the service provider. In some cases, the entity that is the subject of the campaign may have a contractual relationship with the service provider to obtain services related to generating and implementing campaigns to obtain customer feedback. In some situations, the campaign application 324 may be provided by the service provider for execution on the second computing device 304. In various embodiments, the campaign application 324 may obtain at least a portion of the information utilized to provide a campaign from the second computing device 304 and a portion of the information utilized to provide a campaign may generated by the campaign application 324. In this way, the second computing device 304 may utilized the campaign application 324 and/or the campaign date 322 to implement a campaign, obtain reports regarding campaigns, receive alerts regarding escalation events, combinations thereof, and so forth at a location that is remote from the first computing device 302 via communications via the network 306.

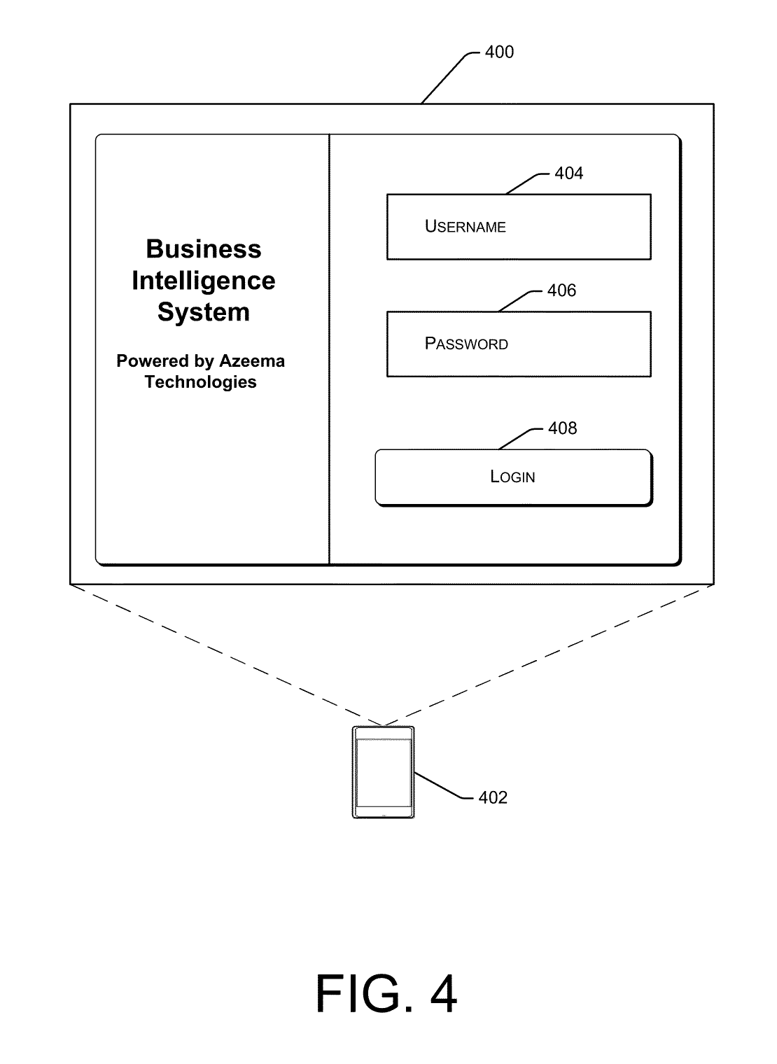

FIG. 4 illustrates a user interface 400 to login in to a system that generates and implements campaigns to obtain customer feedback. The user interface 400 may be displayed by a computing device 402. The computing device 402 may include the electronic device 200 of FIG. 2 or the second computing device 304 of FIG. 3. The user interface 400 may include a first text entry box 404 to obtain a username of a user to log in to an application, such as the campaign application 324 of FIG. 3, in order to implement a campaign and obtain customer feedback. Additionally, the user interface 400 may include a second text entry box 406 to obtain a password of the user to log into the campaign application. Further, the user interface 400 may include a button 408 that is selectable to submit the username and password of the user to log in to an application or system to implement a campaign.

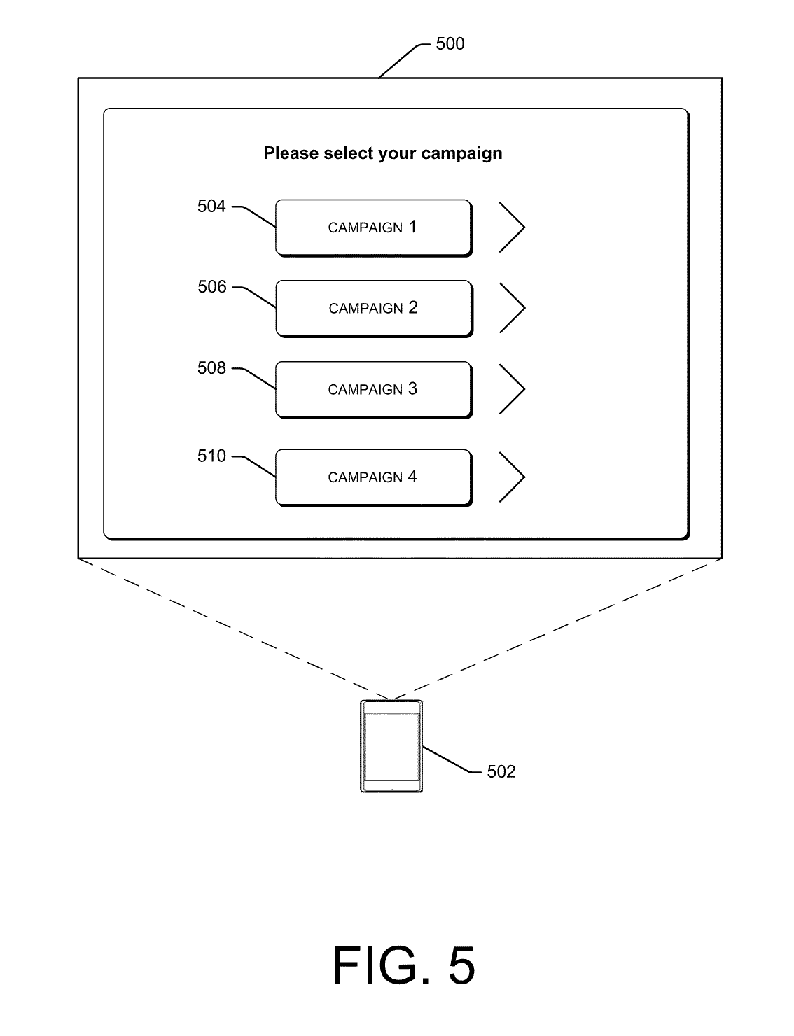

FIG. 5 illustrates a user interface 500 to select a campaign to be launched in order to obtain customer feedback. The user interface 500 may be displayed by a computing device 502. The computing device 502 may include the electronic device 200 of FIG. 2 or the second computing device 304 of FIG. 3. The user interface 500 may include a first button 504, a second button 506, a third button 508, and a fourth button 510 that are selectable to select a campaign to be implemented. In some cases, the campaign may be implemented by the campaign application 324 of FIG. 3, the campaign creation engine 108 of FIG. 1 and FIG. 2, the campaign deliver engine 114 of FIG. 1 and FIG. 2, the campaign results processing engine 120 of FIG. 1 and FIG. 2, or combinations thereof.

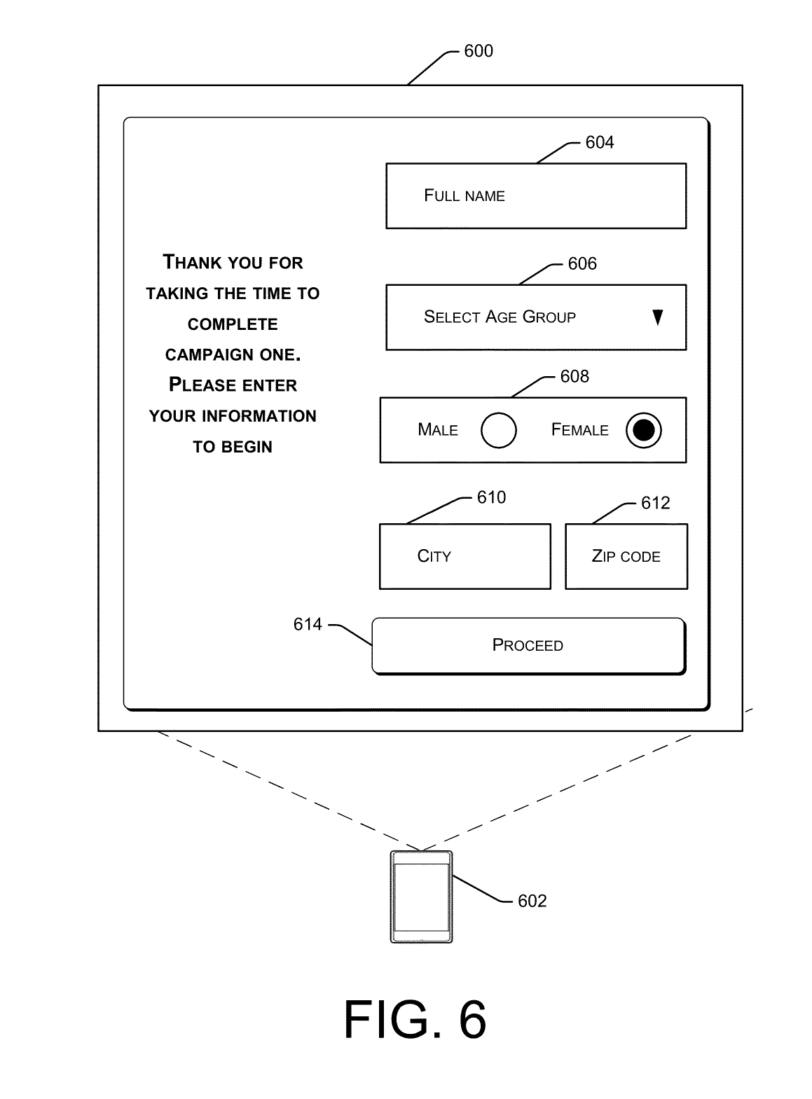

FIG. 6 illustrates a user interface 600 to obtain identification information associated with a customer. The user interface 600 may be displayed by a computing device 602. The computing device 602 may include the electronic device 200 of FIG. 2 or the second computing device 304 of FIG. 3. The user interface 600 may include a number of user interface elements to obtain information related to a customer providing feedback in relation to a campaign. In some cases, the user interface 600 may be displayed in response to selection of a campaign, such as via the user interface 500 of FIG. 5. In other cases, the user interface 600 may be displayed in response to another triggering event, such as a customer purchasing a product and/or service from an entity that is the subject of the campaign.

The user interface 600 may include a first text entry box 604 to obtain a name of the customer. Although, FIG. 6 shows that the full name of the user may be obtained using a single text entry box, in other embodiments, additional text entry boxes may be utilized. Additionally, the user interface 600 includes a drop down menu that include options that are selectable to indicate an age group of the customer. Further, the user interface 600 includes a box 608 including radio buttons that are selectable to indicate whether a customer is male or female. The user interface 600 also includes additional text entry boxes 610 and 612 to obtain input regarding a city of residence of the customer and the zip code of the customer, respectively. In addition, the user interface 600 includes a button 614 that is selectable to provide the information to a campaign application or a service provide and to initiate a campaign. In some embodiments, the user interface 600 may include more user interface elements than those shown in FIG. 6 or fewer user interface elements than those shown in FIG. 6.

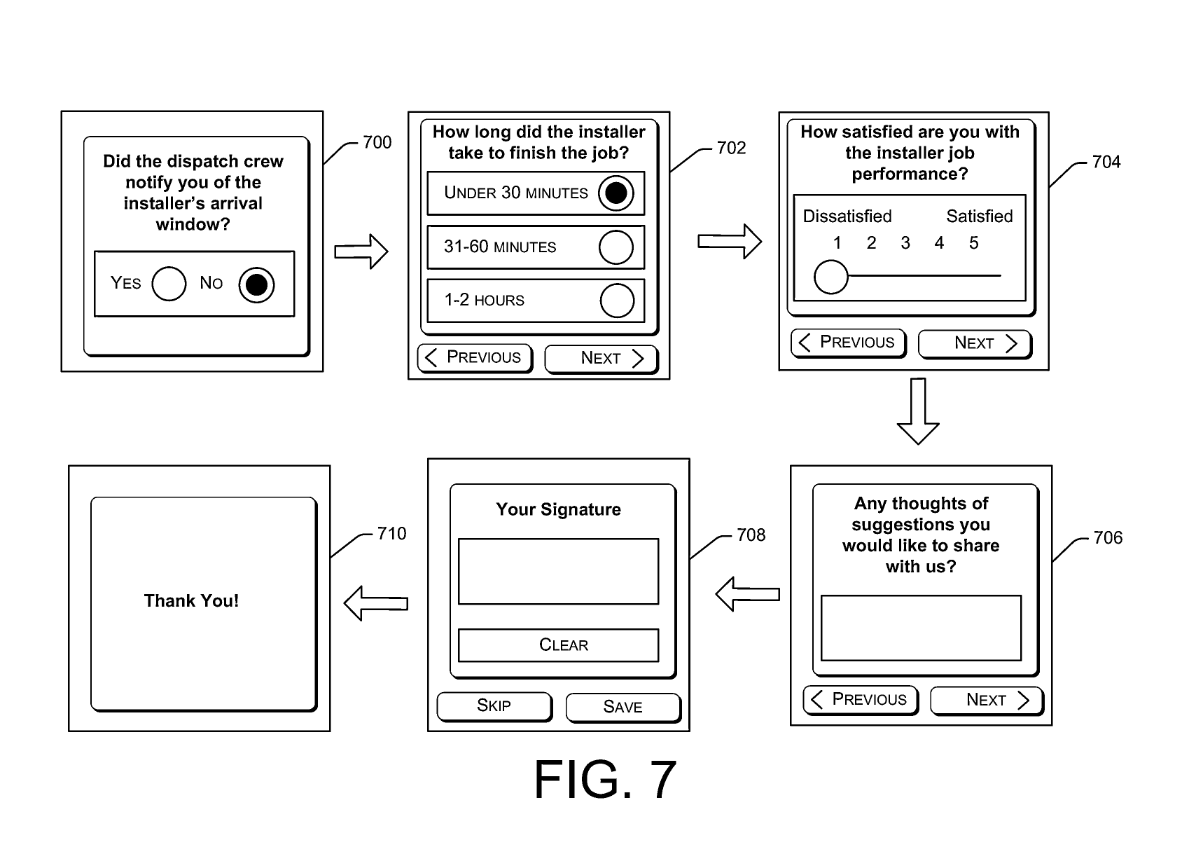

FIG. 7 illustrates a plurality of user interfaces to be provided during a campaign to obtain customer feedback. The user interface 700 may be displayed by a computing device (not shown), such as the electronic device 200 of FIG. 2 or the second computing device 304 of FIG. 3. In some embodiments, the user interfaces included in FIG. 7 may be provided after a customer selects the proceed button 614 of FIG. 6 or after a representative of an entity that is the subject of the campaign logs in after selecting a campaign via the user interface 500 of FIG. 5.

In particular, FIG. 7 includes a first user interface 700 indicating a first question of a campaign and user interface elements (e.g., radio buttons) to obtain an answer to the question. FIG. 7 also includes a second user interface 702 that includes a second question of a campaign and user interface elements to indicate an answer to the question. In this case, the user interface 702 includes a multiple choice question having three possible answers. The user interface 702 may also include buttons that are selectable to move to a previous question of the campaign or to a next question of the campaign. Additionally, FIG. 7 includes a user interface 704 that includes a third question of a campaign and a slider ball that may be used to provide an answer to the question. The user interface 704 also includes buttons that are selectable to move to a previous question of the campaign or to a next question of the campaign. Further, FIG. 7 includes a user interface 706 that includes a fourth question of the campaign and a text entry box to obtain an answer to the fourth question. The user interface 706 also includes buttons that are selectable to move to a previous question of the campaign or to a next question of the campaign. FIG. 7 also includes a user interface 708 that includes a box that enables a customer to provide an electronic signature after completing the questions of the campaign. The user interface 708 also includes a first button to clear the electronic signature and provide a new electronic signature, a second button to skip providing an electronic signature, and a third button to save the electronic signature. FIG. 7 further includes a user interface 710 that includes a message to the customer after completing the campaign. In some additional embodiments, the user interface 710 may also include a reward that is provided to the customer for completing the campaign.

Although, the illustrative example of FIG. 7 indicates that the user interfaces 700, 702, 704, 706, 708, and 710 are provided in a particular sequence, the user interface 702, 704, 706, 708, and 710 may be presented in a different order. In some cases, additional user interfaces may be provided during the campaign, such as user interfaces including additional questions of the campaign, user interfaces including supplemental information regarding the campaign or questions of the campaign, or both, such as Terms and Conditions regarding providing answers to the campaign and/or service agreements between a customer and an entity that is the subject of the campaign. The questions of the campaign, the answers of the campaign, and the sequencing of the questions in the campaign may be determined according to embodiments previously described with respect to FIG. 1, FIG. 2, and/or FIG. 3.

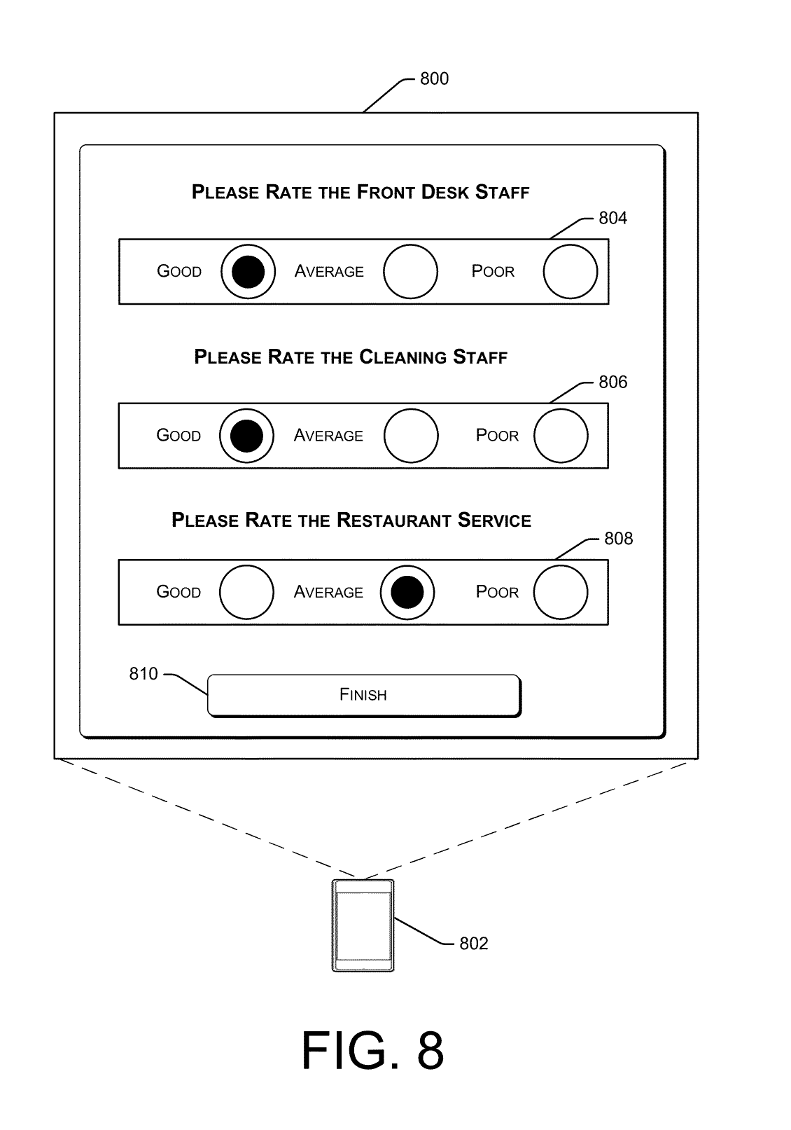

FIG. 8 illustrates a user interface 800 including a number of questions to obtain customer feedback in association with a campaign. The user interface 800 may be displayed by a computing device 802. The computing device 802 may include the electronic device 200 of FIG. 2 or the second computing device 304 of FIG. 3. In some embodiments, the user interfaces included in FIG. 7 may be provided after a customer selects the proceed button 614 of FIG. 6 or after a representative of an entity that is the subject of the campaign logs in after selecting a campaign via the user interface 500 of FIG. 5. The user interface 800 includes three questions of a campaign. An answer to a first question of the campaign may be provided via a first box 804 that includes a number of radio buttons selectable to provide an answer to the first question. An answer to a second question of the campaign may be provided via a second box 806 that includes a number of radio buttons selectable to provide an answer to the second question. An answer to a third question of the campaign may be provided via a third box 808 that includes a number of radio buttons selectable to provide an answer to the third question. The user interface 800 may also include a button 810 that is selectable to enter the answers provided via boxes 804, 806, and 808. Although, the illustrative example of FIG. 8 shows the user interface 800 including boxes having radio buttons for providing answers to questions of a campaign, the user interface 800 may include different and/or additional user interface elements to obtain answers to questions of a campaign.

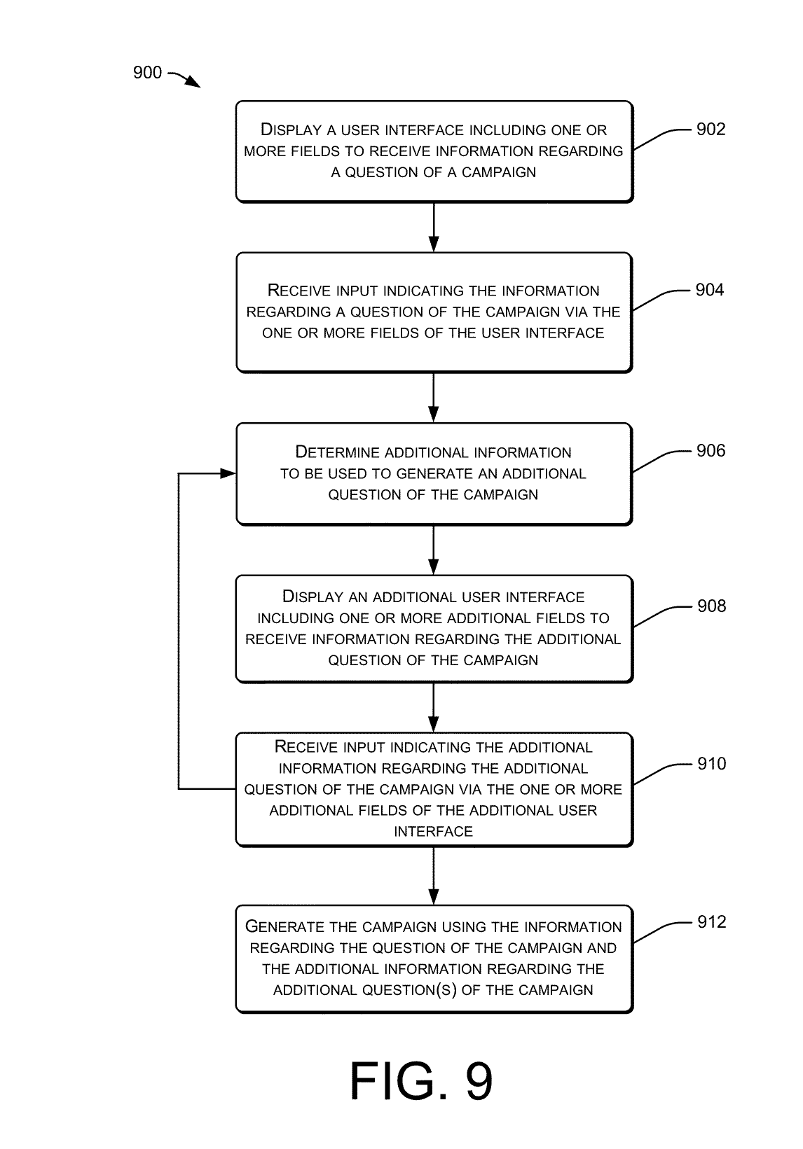

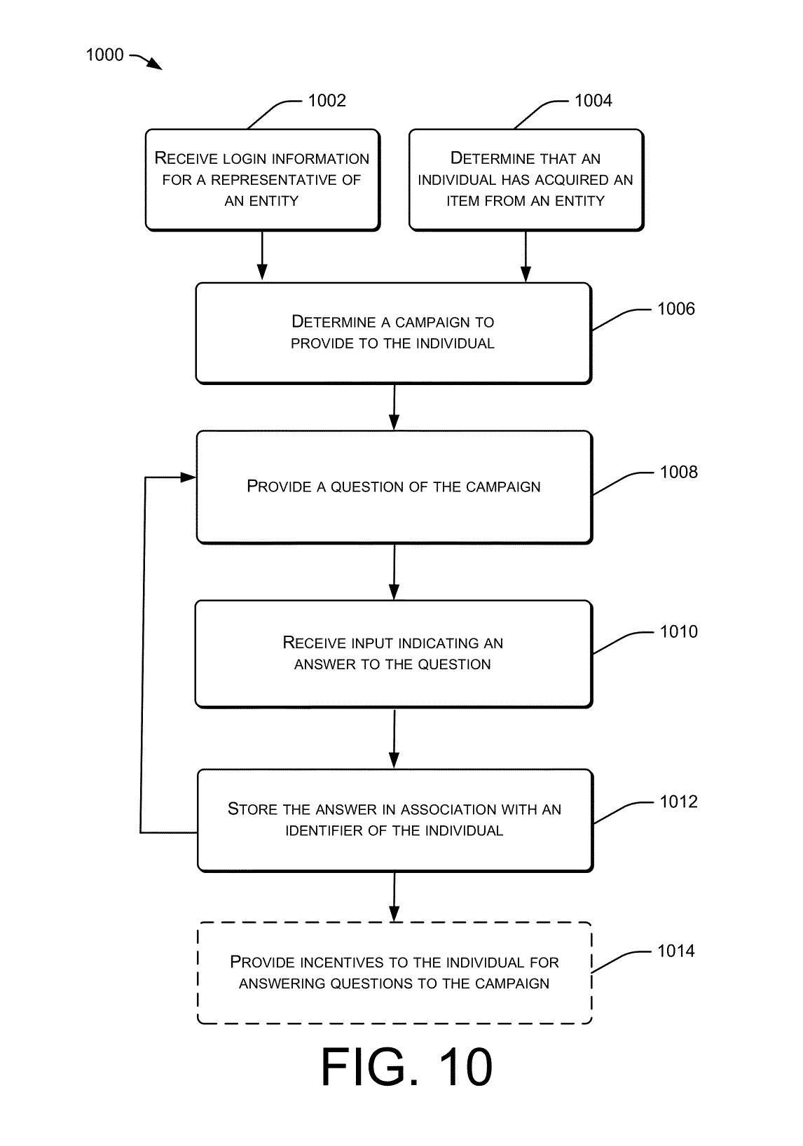

FIGS. 9 and 10 are flow diagrams illustrating example processes for generating and implementing campaigns to obtain information regarding products and services provided an entity. The processes are illustrated as a collection of blocks in a logical flow diagram, which represent a sequence of operations, some or all of which can be implemented in hardware, software or a combination thereof. In the context of software, the blocks represent computer-executable instructions stored on one or more computer-readable media that, when executed by one or more processors, perform the recited operations. Generally, computer-executable instructions include routines, programs, objects, components, data structures and the like that perform particular functions or implement particular abstract data types. The order in which the operations are described should not be construed as a limitation. Any number of the described blocks can be combined in any order and/or in parallel to implement the process, or alternative processes, and not all of the blocks need be executed. For discussion purposes, the processes herein are described with reference to the frameworks, architectures and environments described in the examples herein, although the processes may be implemented in a wide variety of other frameworks, architectures or environments. The processes 900 and 1000 may be implemented, in some cases, by the systems, environments, architectures, devices, or combinations thereof described with respect to FIGS. 1-8.

FIG. 9 illustrates a flow diagram of an example process 900 to generate a campaign to obtain customer feedback. At 902, the process 900 includes displaying a user interface including one or more fields to receive information regarding a question of a campaign. For example, the user interface may include a user interface feature, such as a text entry box that may accept text content related to a question of a campaign. In some cases, the user interface may be displayed based on information received from a service provider. In other situations, the user interface may be generated by a campaign application executing on a computing device.

At 904, the process 900 includes receiving input indicating the information regarding a question of the campaign via the one or more fields of the user interface. To illustrate, a representative of an entity may enter text of a question for a campaign via the user interface displayed with respect to operation 902 and the text may be provided to a service provider, in some cases, to a campaign application in other instances, or both, such as upon selection of a button to submit the text of the question. In some situations, one or more answers to the question may be obtained. In an embodiment, the answers may be obtained via the same user interface used to obtain content associated with the question. In other instances, the one or more answers may be obtained via one or more additional user interfaces provided by a service provider, a campaign application, or both.

At 906, the process 900 includes determining additional information to be used to generate an additional question of the campaign. In an embodiment, the text of the previously submitted question may be used to generate a second question to the campaign. The text of the previously submitted question may also be used to generate a template for an additional question or a suggestion for at least a portion of an additional question. At 908, the process 900 includes displaying an additional user interface including one or more additional fields to receive information regarding the additional question of the campaign. In some cases, the one or more additional fields may include user interface elements for entering text. In other cases, the one or more additional fields may include user interface elements that enable a representative of an entity to select suggested questions for a campaign or to select suggested portions of questions for a campaign.

At 910, the process 900 includes receiving input indicating the additional information regarding the additional question of the campaign via the one or more additional fields of the additional user interface. For example, a service provider, a campaign application, or both may receive text of the additional question. In some cases, one or more answers to the question may also be obtained. When a user selects to add more questions to the campaign, the process 900 may return to 906, 908, and 910 until all of the questions and/or answers of a campaign are submitted. After all of the questions and/or answers of the campaign are submitted, the process moves to 912 where the campaign is generated using the information regarding the question of the campaign and the additional information regarding the additional questions of the campaign. In an embodiment, the process 900 may also include generating and/or obtaining sequencing information indicating a sequence that the questions are to be provided. In some cases, the sequence that the questions are provided in may depend on answers to previous questions.

FIG. 10 illustrates a flow diagram of an example process 1000 to provide a campaign to obtain customer feedback. The process 1000 includes operation 1002 of receiving login information of a representative of an entity that is the subject of a campaign. In some cases, the representative of the entity may provide the login information to access a campaign application that may generate and/or implement a campaign to obtain customer feedback. In an embodiment, the login information of the representative of the entity may be verified before the process 1000 proceeds.

At 1004, the process 1000 includes determining that an individual has acquired an item from an entity. For example, a customer of a merchant may purchase a product and/or service from the merchant. In some cases, after determining that a representative of the entity has logged in to the campaign application or that an individual has acquired an item from an entity, a triggering event signal may be generated. In an embodiment, the individual may acquire the item from the entity via a transaction between the individual, the entity, and one or more third-party payment services providers, such as a bank, an electronic payment services organization, a credit agency, another financial institution, combinations thereof, and the like. In various scenarios, the transaction for the individual to acquire the item from the entity may have been initiated, but may not have been completed before the process 1000 moves on from 1004. In other instances, the transaction for the individual to acquire the item from the entity may have been completed when the process continues from 1004.

After either 1002 or 1004, the process 1000 may proceed to 1006 that includes determining a campaign to provide to the individual. In some cases, determining the campaign to provide to the individual may include identifying the campaign based on input received from the representative of the merchant or the individual indicating selection of a particular campaign to implement. In other cases, determining the campaign to provide to the individual may be based on characteristics of the individual, history of interaction between the individual and the entity, preferences of the individual, preferences of the entity, or a combination thereof. For example, an entity may submit preference information indicating that customers in a first location are to receive a first campaign and customers in a second location are to receive a second campaign. In another example, an entity may specify that a customer purchasing a first type of item, such as a steak dinner at a restaurant, is to receive a first campaign, while a customer purchasing a chicken salad at the restaurant, is to receive a second campaign. Further, an individual may provide preferences indicating that the individual is to receive campaigns associated with a first type of entity, such as clothing stores, but not a second type of entity, such as grocery stores.

At 1008, the process 1000 includes providing a question of the campaign. To illustrate, the question of the campaign may be provided via a user interface, via an audio output device, or both. The user interface may be displayed by a campaign application executing on a computing device, on a website of the entity, on a website of a service provider, or a combination thereof. Additionally, at 1010, the process 1000 includes receiving input indicating an answer to the question. The answer to the question may be provided via a user interface, via an input device, such as a camera or microphone, or a combination thereof. At 1012, the answer to the question may be stored in association with an identifier of the individual. In this way, a service provider may analyze answers provided by customers to determine trends and to provide reporting to the entity. In some embodiments, the reports may include graphs, tables, charts, or other visual representations of data associated with campaigns of the entity. The reports may be accessible to particular representatives within the entity based on permissions provided to representatives of the entity.

When the campaign includes additional questions, the process 1000 may return to 1008, 1010, and 1012 until all of the questions of the campaign have been answered. In situations, where a transaction for the individual to acquire the item from the entity has not been completed by the time the questions to the campaign have been answered, the transaction may be completed when answers to all or at least a portion of the answers to the questions of the campaign have been received. In some cases, the process 1000 may optionally include, at 1014, providing incentives to the individual for answering questions of the campaign. The incentives may include reward points to acquire items from the entity or from another entity, a discount on a purchase from the entity by the individual, a coupon for future discounts on purchases by the individual from the entity or from a different entity, or a combination thereof.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

What is claimed is:

1. A computing device comprising:
one or more processors; and
one or more computer-readable storage media in communication with the one or more processors, the one or more computer-readable storage media storing computer readable instructions that, when executed by the one or more processors, perform operations including:
determining that a transaction for a customer to acquire an item from an entity has been initiated or receiving login information from a representative of the entity via a user interface;
at least partly in response to determining that the transaction for the customer to acquire the item from the entity has been initiated or at least partly in response to receiving input indicating selection of a campaign from the representative of the entity after verifying the login information of the representative of the entity, providing one or more questions of a campaign to the individual, wherein the campaign is associated with the entity,
receiving a respective answer to individual questions of the one or more questions from the individual;
determining that the respective answers to the one or more questions satisfy a threshold criteria for determining that an escalation event has occurred; and.
sending an alert to an additional representative of the entity based at least partly on determining that the escalation event has occurred.

2. The computing device of claim 1, wherein the operations further comprise:
providing a user interface to the representative of the entity, the user interface including one or more fields to accept input regarding the question of the campaign; and
adding the question to the campaign in response to receiving the input entered into the one or more fields of the user interface.

3. The computing device of claim 1, wherein the operations further comprise:
providing a user interface to the representative of the entity, the user interface including one or more fields to accept input regarding the answer to the question of the campaign.

4. The computing device of claim 1, wherein the operations further comprise generating an additional question for the campaign based at least partly on content of the question; and receiving input from the representative of the entity to add the additional question to the campaign.

5. A method comprising:
determining, by a computing device including a processor, that a transaction for a customer to acquire an item from an entity has been initiated;
at least partly in response to determining that the transaction for the customer to acquire the item from the entity has been initiated, providing, by the computing, a question of a campaign to the individual, wherein the campaign is associated with the entity,
receiving, by the computing device, an answer to the question from the individual; and
determining, by the computing device, an action to perform based at least in part on the answer to the question.

6. The method of claim 5, wherein the action includes sending an alert to a representative of the entity based at least in part on the answer to the question by the individual.

7. The method of claim 5, wherein the action includes providing incentives to the individual.

8. The method of claim 5, wherein the action includes obtaining video feedback from the individual.

9. The method of claim 5, wherein the question of the campaign is provided to the individual before the transaction is completed.

10. The method of claim 5, wherein the campaign includes a plurality of answers, and the transaction for the individual to acquire the item is completed after receiving answers to at least a portion of the plurality of questions.

11. The method of claim 5, further comprising:
receiving, by the computing device, respective answers to the question of the campaign from a plurality of individuals; and
determining metrics associated with the respective answers to the question of the campaign.

12. The method of claim 11, wherein the action includes providing a report to the entity in response to receiving a request from a computing device of the entity via a network, the report including graphical elements indicating the metrics.

13. The method of claim 5, wherein the question is a first question of a plurality of questions of the campaign, and the method further comprising:
determining that a second question of the plurality of questions is to be provided to the individual after receiving the answer to the question based at least partly on sequencing information of the campaign, the sequencing information indicating an order in which to provide the plurality of questions of the campaign.

14. The method of claim 13, wherein the answer is a first answer of a plurality of answers to the first question, and the sequencing information indicates that the second question is to be provided to individuals in response to receiving the first answer to the first question and a third question is to be provided to the individuals in response to receiving a second answer to the first question.

15. One or more computer-readable media storing computer-executable instructions that, when executed by one or more processors, cause the one or more processors to perform operations comprising:
receiving login information from a representative of an entity via a user interface;
receiving input indicating selection of a campaign from the representative of the entity after verifying the login information of the representative of the entity;
at least partly in response to receiving the input indicating the selection of the campaign by the representative of the entity, displaying a question of a campaign associated with the entity;
receiving an answer to the question from an individual that is different from the representative of the entity; and
determining an action to perform based at least in part on the answer to the question.

16. The one or more computer-readable media of claim 15, wherein the operations further comprise receiving identifier information associated with the individual before displaying the question of the campaign.

17. The one or more computer-readable media of claim 15, wherein the operations further comprise providing answers to the question in real-time to a computing device of the entity via a network.

18. The one or more computer-readable media of claim 15, wherein the question is one of a plurality of questions, and individual questions of the plurality of questions and one or more answers corresponding to the individual questions are displayed in respective user interfaces.

19. The one or more computer-readable media of claim 15, wherein the question is one of a plurality of questions, and individual questions of the plurality of questions and one or more answers corresponding to the individual questions are displayed in a single user interface.

20. The one or more computer-readable media of claim 15, wherein:
the question is a multiple choice question and the answer to the question is one of a plurality of answers to the question;
the answer to the question includes a rating on a scale of ratings; or
the answer includes text content provided by a customer of the entity.
